(19) United States
(12) Patent Application Publication
(10) Pub. No.: US 2025/0166086 A1
(43) Pub. Date: May 22, 2025

(54) COMPUTER-IMPLEMENTED METHODS AND SYSTEM FOR AUTOMATIC TIME TRACKING

(71) Applicant: Benjamin Traub, Englewood, FL (US)

(72) Inventor: Benjamin Traub, Englewood, FL (US)

(21) Appl. No.: 18/514,049

(22) Filed: Nov. 20, 2023

(51) Int. Cl. G06Q 40/12; G06Q 30/04

(52) U.S. Cl. CPC G06Q 40/125; G06Q 30/04

(57) ABSTRACT

The invention comprises a computer-implemented method for automatic time tracking, that further comprises: establishing a convention for file names comprising unique task metadata; naming one or more files according to the established convention; measuring, at a computing device used by a worker, the active window over one or more intervals of time; matching the active windows measured over the one or more intervals of time to the one or more files; and tabulating total time spent by the worker by one or more unique task metadata components.

### BACKGROUND

In certain industries, it is common to bill clients based on the number of hours spent on a client matter, and apart from billing, there may be other uses for collecting data about time spent on projects by those working on the projects. Prior-art patent literature describes a number of computer-implemented methods and systems related to tracking time for billing and other purposes.

Nevertheless, prior-art methods and systems for computerized time tracking are often inconvenient and prone to errors. Improved means of automatically tracking the time of workers for billing and other purposes are highly desirable.

### SUMMARY OF INVENTION

The present invention provides systems and methods for automatically tracking worker time to specific tasks, making the tracking both more convenient and less prone to errors.

According to one embodiment of the present invention, there is a computer-implemented method for automatic time tracking, comprising: establishing a convention for file names comprising unique task metadata; naming one or more files according to the established convention; measuring, at a worker computing device, the active window over one or more intervals of time; matching the active windows measured over the one or more intervals of time to the one or more files; and tabulating total time spent by the worker by one or more unique task metadata components.

According to another embodiment of the present invention, the method comprises: one or more folders for a task in a digital file system; storing one or more files with unique metadata inside the one or more folders; creating a folder-to-task index; creating a file-to-task index, based on a file-to-folder index and the storage location of the file; matching the active windows, measured over one or more intervals of time, to the one or more files; and tabulating total time spent by the worker by the file-to-task index.

According to a third embodiment of the present invention, it is a system for automatic time tracking comprising: at least one display device associated with, and communicatively connected to, a worker computing device; a database stored on a computer-readable medium; and at least one processor operative for: measuring, at the worker computing device, the active window over one or more intervals of time; matching the active windows measured over the one or more intervals of time to the one or more files stored in the database.

### BRIEF DESCRIPTION OF THE DRAWINGS

FIG. 1 illustrates file names according to an embodiment of the present invention;

FIG. 2 illustrates file identification number indexes and task identification number indexes;

FIG. 3 illustrates folder IDs and task IDs; and

FIG. 4 illustrates file IDs and folder IDs.

### DETAILED DESCRIPTION

Classification of worker time to specific tasks generally requires the worker to manually indicate which task they are working on, either throughout the day, or after the work has been completed. This can lead to inaccuracies due to inattention or faulty memory of the worker, and also consumes non-billable worker time. The present invention solves those problems by automating the time tracking process for workers who use a computing device to perform their work.

The present invention automatically assigns worker time to specific tasks by comparing the metadata of digital files that the worker is focused on, and the amount of time the file is in focus, to a file-to-task index that relates the file's metadata to specific tasks. Time that a worker has focused on specific files may be automatically classified, relating it to specific clients, projects or tasks.

For reference, objects such as tasks, projects or clients may all be referred to in this document as tasks. A file can include items such as spreadsheets, text documents, and the like.

Two embodiments are disclosed: Indexable File Name; and Folder Content Index.

Both methods rely on the collection of “focus data, “defined as data that describes what a worker is focused on at any moment in time, on their computing device. This is sometimes referred to as “active window’ data,” as it relates to the window on the device that is active or currently in focus. Focus data may be collected from a worker's computing device using software that is operative, in conjunction with supporting hardware subsystems, to monitor and collect information related to the active window that a worker has in focus. Both methods record how much time each window remains active.

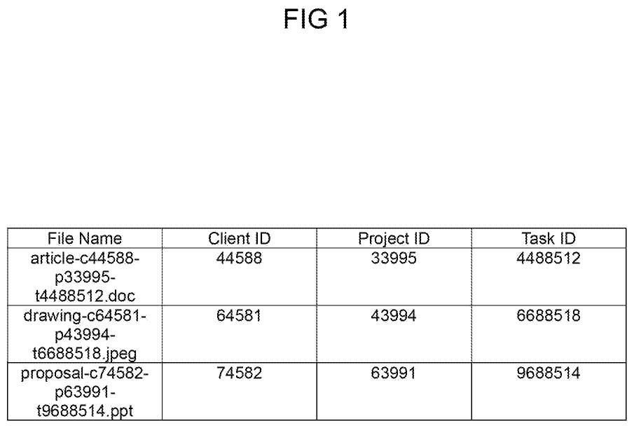

The Indexable File Name embodiment is illustrated in FIG. 1. It uses unique taskmeta data, such as task ID (101), included in the file name. For example a file name could be article-c44588-p33995-t4488512.doc (102), where c=client ID (103), p=project ID (104), t=task ID (105). Because focus data contains the file name, from which the task ID can be parsed, all time that the window remained in focus can now be associated with the correct task.

If the above example file (c44588-p33995-t4488512.doc) was in focus for 15 minutes by user ID 4, then it is possible to compute that user 4 worked on task_id=4488512 for 15 minutes. Task 4488512 might or might not have the same billing rate as other tasks for the same project 33995 which might or might not have the same billing rate as other projects for the same client 44588.

It is also possible that one or more levels of sub-tasks could be included in the file name, for example c44588-p33995-t4488512-s892741413.doc, where s=subtask ID.

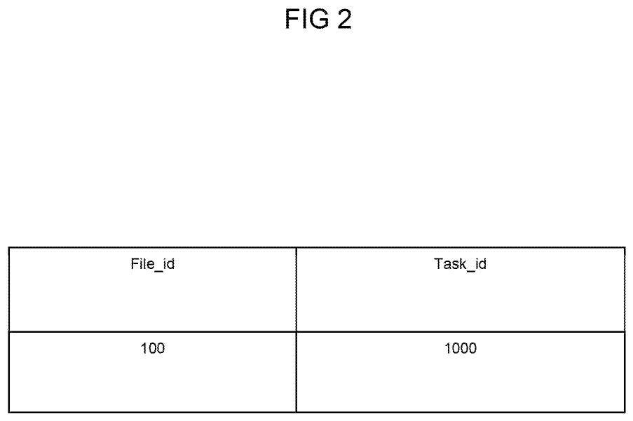

The Folder Content Index embodiment is illustrated in FIGS. 2, 3 and 4. It uses one or more folders created for each task, with the folders contained in a digital file system. Files with unique metadata, for each task, are stored inside those folders. A file-to-task index is created, associating the file's unique metadata to specific tasks, as shown in FIG. 2.

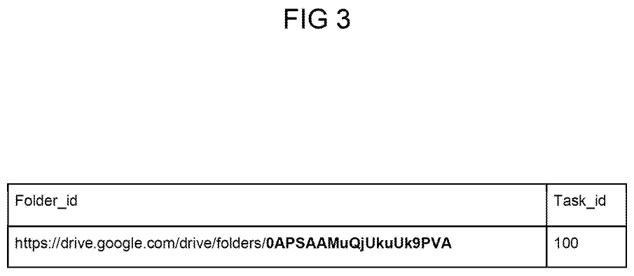

As an example, creating a file-to-task index may be created as follows. A folder-to-task index is created, associating the unique folder metadata (such as folder name, ID or URL) to specific tasks, as shown in FIG. 3. The folders are populated with digital “task” files, each of which has unique metadata.

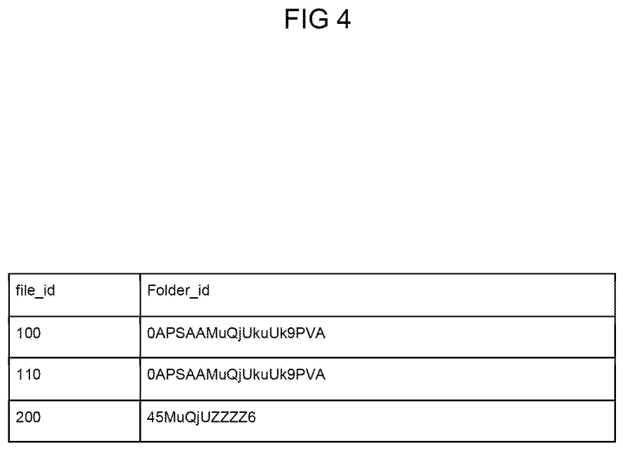

It is possible to create a file-to-folder index by using an application program interface (API), such as the Google Drive API, or a scraping script, to get a list of all folders and files within those folders. That index can be stored in a table, as shown in FIG. 4.

Then, a query can be performed to match the files with tasks, by joining the folder-to-task index with the file-to-folder index. The results can be output to a file-to-task index, as shown in FIG. 2.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description.

Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than in a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiments disclosed.

What is claimed is:

1. A computer-implemented method for automatic time tracking, comprising:
establishing a convention for file names comprising unique task metadata;
naming at least one file according to an established convention;
measuring, at a worker computing device, an active window during at least one time interval;
matching active windows, measured over the at least one time interval, to the at least one file; and
tabulating total time spent by the worker based on at least one unique task metadata component.

2. The method of claim 1, further comprising generating an invoice based on the tabulation of the total time spent by the worker.

3. The method of claim 1, wherein the unique task metadata comprises a client identification.

4. The method of claim 1, wherein the unique task metadata comprises a project identification associated with the client identification.

5. The method of claim 1, wherein the unique task metadata comprises the task identification associated with a project identification.

6. The method of claim 1, wherein the unique task metadata comprises a subtask identification associated with the task identification.

7. A computer-implemented method for automatic time tracking, comprising:
creating at least one folder for a task in a digital file system;
storing at least one file, with unique metadata, inside the at least one folder;
creating a folder-to-task index;
creating a file-to-task index based on a file-to-folder index and a storage location of the file;
matching the active window, measured over at least one time interval, to the at least one file; and
tabulating total time spent by the worker by the file-to-task index.

8. The method of claim 7, wherein the at least one file contains at least one email, document, presentation, database, voicemail, audio file, image file, video file, social media, and web site.

9. The method of claim 7, further comprising ranking at least one task in terms of value, using an hourly-rate scale for ranking.

10. The method of claim 9, further comprising tabulating a total rate for at least one task.

11. The method of claim 7, wherein an API is used to create at least one index.

12. The method of claim 7, wherein the at least one index is created by using a scraping script to scan file data.

13. A system for automatic time tracking, comprising:
at least one display device associated with, and communicatively connected, to a computing device used by a worker;
a database stored on a computer-readable medium; and
at least one processor operative to:
measure, at the computing device used by a worker, the active window over at least one interval of time; and
match the active window, measured over the at least one interval of time, to the at least one file stored in the database.

14. The system of claim 13, further comprising a remote server.

15. The system of claim 14, wherein matching the at least one active window, measured over the at least one interval of time, to the at least one file, is executed on a remote server.

16. The system of claim 13, wherein the at least one processor is further operative to:
establish a convention for file names comprising unique task metadata;
name the at least one file according to an established convention; and
tabulate total time spent by a worker on at least one unique task metadata component.

17. The system of claim 13, wherein the at least one processor is further arranged operative to:
create at least one folder, in a digital file system, for at least one task;
store at least one file, with unique metadata, inside the at least one folder;
create a folder-to-task index;
create a file-to-task index, based on a file-to-folder index and a storage location of the file; and
tabulate total time spent by a worker based on the file-to-task index.

18. The system of claim 13, further comprising at least one input/output device associated with, and communicatively connected, to the computing device used by a worker.

19. The system of claim 18, wherein the at least one processor is further operative to:
monitor and record inputs at least one input/output device, associated with and communicatively connected, to the computing device used by a worker, over at least one interval of time.

20. The system of claim 19, wherein the at least one processor is further operative to:
match inputs, measured over the at least one time interval to the at least one file.
